(19) United States
(12) Patent Application Publication
(10) Pub. No.: US 2011/0130042 A1
(43) Pub. Date: Jun. 2, 2011

(54) MINI PCI EXPRESS CONNECTOR

(76) Inventor: Wan-Tien CHEN, Taipei (TW)

(21) Appl. No.: 12/626,764

(22) Filed: Nov. 27, 2009

(51) Int. Cl. H01R 24/00

(52) U.S. Cl. 439/660

(57) ABSTRACT

The present invention relates to a mini PCI express connector, comprises an insulation housing having an insertion surface and rear surface opposite to the insertion surface, the rear surface is respectively installed with a plurality of first terminal channels extending toward the insertion surface and a plurality of second terminal channels extending toward the insertion surface, and at least one scoop hole is installed on the insulation housing; a plurality of first conduction terminals respectively received in the first terminal channels; and a plurality of second conduction terminals respectively received in the second terminal channels. With the scoop hole, the production cost can be lower and the insulation housing is prevented from being deformed.

### BACKGROUND OF THE INVENTION

1. Field of the Invention

The present invention relates to a connector, more particularly to a mini PCI express connector on which at least one scoop hole is installed on an insulation housing for reducing shrinking and deformation of the insulation housing.

2. Description of Related Art

A Peripheral Component Interconnect Express (PCI Express) interface protocol was issued by Intel Corp. at 2004, the interface is provided for replacing conventional interface protocols such as PCI, PCI-X or AGP, so said interface protocol is greatly adopted in various interface cards for a personal computer such as a graphic card or network card.

A conventional mini PCI express connector, for example the electrical connector disclosed at the Taiwan Utility Patent No. M336576 is a mini PCI express connector characterized in that terminals are prevented from being wrongly inserted and deformed and the integral area and the integral height after being assembled with a circuit board are reduced.

Though the mentioned patent is capable of solving problems to which it is invented, the art disclosed in said patent still has following disadvantages: 1. an insulation housing installed thereon is not provided with scoop holes so not only production cost is higher but also the insulation housing has a higher tendency to be deformed; 2. the insulation housing is fastened on a circuit board through insertion pins and pin rods, so the structure thereof is relatively complicated and production cost may be raised.

For improving the mentioned disadvantages of said conventional connector, a novel mini PCI express connector is provided by the present invention.

### SUMMARY OF THE INVENTION

One objet of the present invention is to provide a mini PCI express connector, on which at least one scoop hole is installed on an insulation housing for reducing shrinking and deformation of the insulation housing.

Another object of the present invention is to provide a mini PCI express connector, on which an insulation housing having two ends being installed with a fastening seat, a lock sheet and a tenon for being conveniently connected to a circuit board.

For achieving the objects mentioned above, one solution provided by the present invention is to provide a mini PCI express connector, comprises an insulation housing having an insertion surface and rear surface opposite to the insertion surface, the rear surface is respectively installed with a plurality of first terminal channels extending toward the insertion surface and a plurality of second terminal channels extending toward the insertion surface, the first terminal channels and the second terminal channels are transversally installed, and at least one scoop hole is installed on the insulation housing; a plurality of first conduction terminals respectively received in the first terminal channels; and a plurality of second conduction terminals respectively received in the second terminal channels.

For achieving the objects mentioned above, another solution provided by the present invention is to provide a mini PCI express connector, comprises an insulation housing having an insertion surface and rear surface opposite to the insertion surface, the rear surface is respectively installed with a plurality of first terminal channels extending toward the insertion surface and a plurality of second terminal channels extending toward the insertion surface, the first terminal channels and the second terminal channels are transversally installed, at least one end of the insulation housing is installed with a fastening seat and a lock sheet, the fastening seat is further installed with a latching block and a guiding slot, the lock sheet is installed with a base sheet and a wing sheet, the base sheet and the wing sheet are installed in parallel and a sheet hole is installed on the wing sheet with respect to the location wherein the latching block is installed; a plurality of first conduction terminals respectively received in the first terminal channels; and a plurality of second conduction terminals respectively received in the second terminal channels.

### BRIEF DESCRIPTION OF THE DRAWINGS

FIG. 1 is a schematic exploded view of the mini PCI express connector of one preferred embodiment of the present invention;

FIG. 2 is a schematic front view of the assembly of the mini PCI express connector of one preferred embodiment of the present invention;

FIG. 3 is a schematic rear view of the assembly of the mini PCI express connector of one preferred embodiment of the present invention;

FIG. 4 is a schematic front view illustrating the mini PCI express connector of one preferred embodiment of the present invention being connected to a circuit board;

FIG. 5 is a schematic rear view illustrating the mini PCI express connector of one preferred embodiment of the present invention being connected to a circuit board.

### DETAILED DESCRIPTION OF THE PREFERRED EMBODIMENT

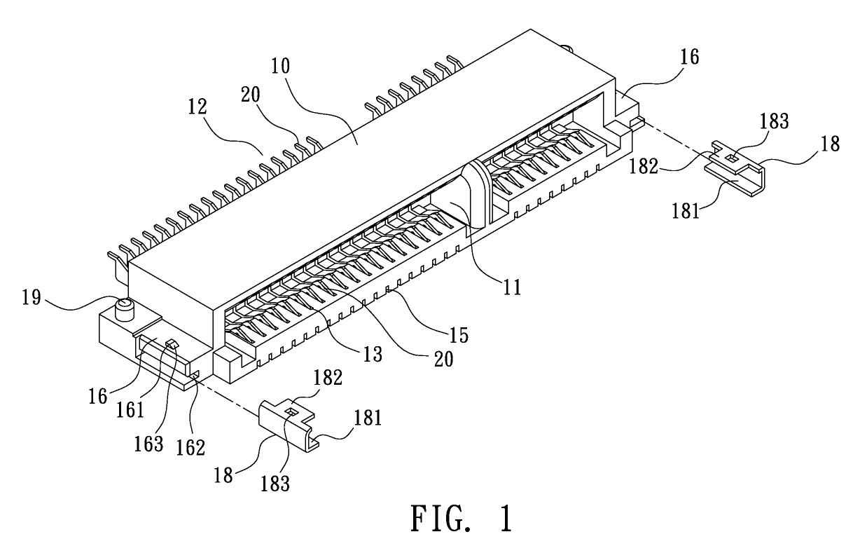

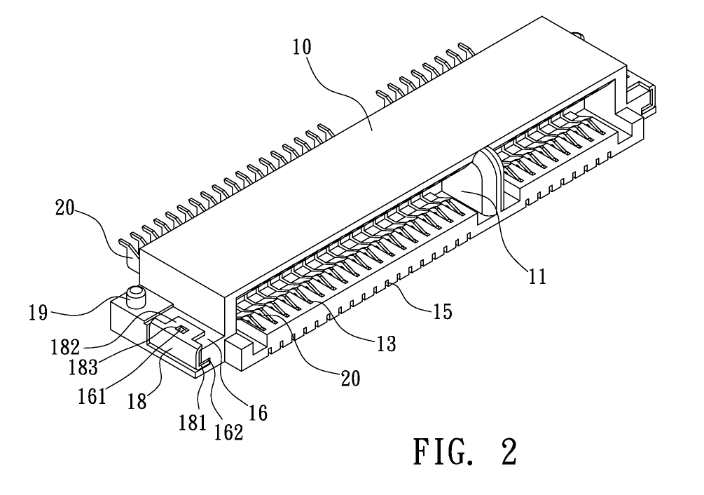

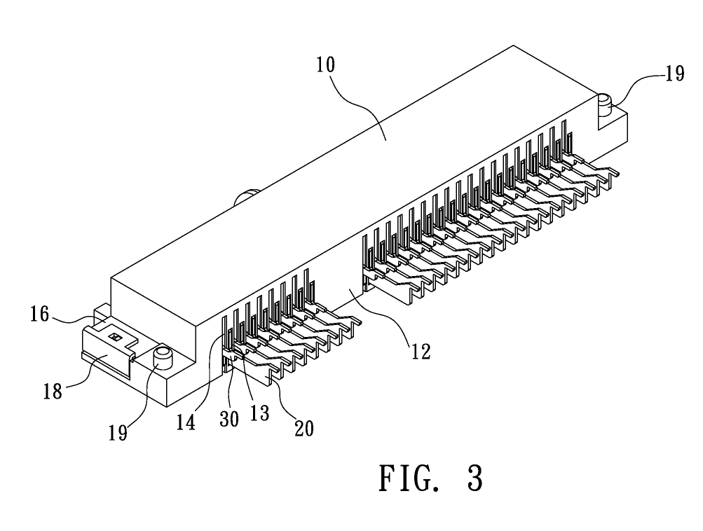

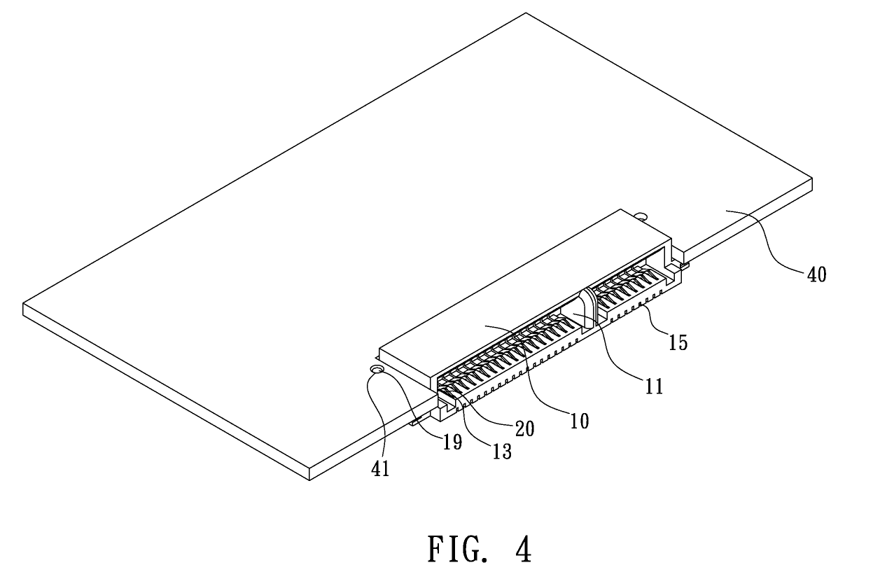

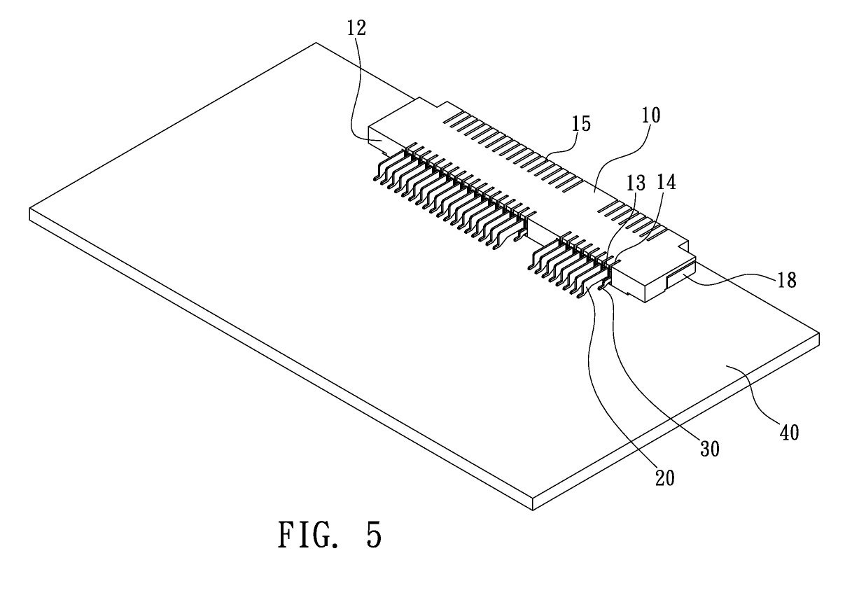

Referring from FIG. 1 to FIG. 5, wherein FIG. 1 is a schematic exploded view of the mini PCI express connector of one preferred embodiment of the present invention; FIG. 2 is a schematic front view of the assembly of the mini PCI express connector of one preferred embodiment of the present invention; FIG. 3 is a schematic rear view of the assembly of the mini PCI express connector of one preferred embodiment of the present invention; FIG. 4 is a schematic front view illustrating the mini PCI express connector of one preferred embodiment of the present invention being connected to a circuit board; FIG. 5 is a schematic rear view illustrating the mini PCI express connector of one preferred embodiment of the present invention being connected to a circuit board.

As shown in figures, the mini PCI express connector provided by the present invention comprises: an insulation housing 10; a plurality of first conduction terminals 20; and a plurality of second conduction terminals 30.

The insulation housing 10 is installed with an insertion surface 11 and a rear surface 12 provided opposite to the insertion surface 11. The rear surface 12 is respectively installed with a plurality of first terminal channels 13 extending toward the insertion surface 11 and a plurality of second terminal channels 14 extending toward the insertion surface 11, and the first terminal channels 13 and the second terminal channels 14 are transversally installed; wherein the insulation housing 10 is made of, e.g. but not limited to, plastic material. Said arts are conventional and well known by skilled people in the art, therefore no further illustration is provided.

The insertion surface 11 of the insulation housing 10 is further installed with at least one scoop hole 15 having a, e.g. but not limited, rectangular shape, so not only the plastic material used is reduced but also shrinking and deformation of the insulation housing 10 are reduced.

Two ends of the insulation housing 10 are respectively installed with a fastening seat 16, a lock sheet 18 and a tenon 19; the fastening seat 16 is further installed with a latching block 161 and a guiding slot 162, the lock sheet 18 is made of, e.g. but not limited to, metal material and has a base sheet 181 and a wing sheet 182 that are parallel to each other, and a sheet hole 183 is installed on the wing sheet 182 with respect to the location where the latching block 161 is installed. The tenon 19 is disposed rear to the fastening seat 16 for being fastened in a tenon hole 41 of a circuit board 40, wherein the circuit board 40 is, e.g. but not limited to, a computer mother board.

The latching block 161 is disposed on at upper end of the fastening seat 16, the guiding slot 162 is disposed below the latching block 161 for allowing the base sheet 181 to sleeve in; two ends of the latching block 161 are respectively provided with a guiding angle 163 for allowing the latching block 161 to sleeve in the sheet hole 183, so that the lock sheet 18 is prevented from being released from the wing sheet 182.

The first conduction terminals 20 are respectively received in the first terminal channels 13, which is a conventional art for general mini PCI express connector therefore no further illustration is provided.

The second conduction terminals 30 are respectively received in the second terminal channels 14, which is a conventional art for general mini PCI express connector therefore no further illustration is provided.

As shown in FIG. 2 and FIG. 3, when being assembled, the first conduction terminals 20 are respectively received in the first terminal channels 13, then the second conduction terminals 30 are respectively received in the second terminal channels 14; the two lock sheets 18 are respectively slid in the corresponding fastening seat 16 through the guiding slot 162, when the latching blocks 161 are received in the sheet holes 183, the assembly of the mini PCI express connector of the present invention is finished.

As shown in FIG. 4 and FIG. 5, when in use, the tenon 19 is inserted in the corresponding tenon hole 41 of the circuit board 40; then the first conduction terminals 20 and the second conduction terminals 30 are respectively soldered on the circuit board 40; lastly the lock sheet 18 is soldered on the circuit board 40, so the soldering connection between the circuit board 40 and the mini PCI express connector of the present invention is finished.

The connector provided by the present invention, comparing to conventional mini PCI express connectors, has following advantages: 1. at least one scoop hole is installed on the insulation housing so shrinking and deformation of the insulation housing are reduced; 2. two ends of the insulation housing are further installed with a fastening seat 16, a lock sheet 18 and a tenon 19, so the lock sheet 18 can be easily connected to the fastening seat 16 then fastened on the circuit board 40.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mini PCI express connector, comprising:
an insulation housing having an insertion surface and rear surface opposite to the insertion surface, said rear surface being respectively installed with a plurality of first terminal channels extending toward said insertion surface and a plurality of second terminal channels extending toward said insertion surface, said first terminal channels and said second terminal channels being transversally installed, and at least one scoop hole being installed on said insulation housing;
a plurality of first conduction terminals respectively received in said first terminal channels; and
a plurality of second conduction terminals respectively received in said second terminal channels.

2. The mini PCI express connector according to claim 1, wherein said insulation housing is made of plastic material, and said scoop hole is disposed below said insertion surface.

3. The mini PCI express connector according to claim 1, wherein said scoop hole is in a rectangular shape.

4. The mini PCI express connector according to claim 1, wherein two ends of said insulation housing are respectively installed with a fastening seat, a lock sheet and a tenon, said fastening seat is further installed with a latching block and a guiding slot, said lock sheet is made of metal material and has a base sheet and a wing sheet that are disposed in parallel, a sheet hole is installed on said wing sheet with respect to the location where said latching block is installed, and said tenon is fastened in a tenon hole of a circuit board.

5. The mini PCI express connector according to claim 4, wherein said latching block is disposed at an upper end of said fastening seat, said guiding slot is disposed below said latching block for allowing said base sheet to sleeve in; two ends of said latching block are respectively provided with a guiding angle for allowing said latching block to sleeve in said sheet hole, so that said lock sheet is prevented from being released from said wing sheet.

6. A mini PCI express connector, comprising:
an insulation housing having an insertion surface and rear surface opposite to said insertion surface, said rear surface is respectively installed with a plurality of first terminal channels extending toward said insertion surface and a plurality of second terminal channels extending toward said insertion surface, said first terminal channels and said second terminal channels are transversally installed, at least one end of said insulation housing is installed with a fastening seat and a lock sheet, said fastening seat is further installed with a latching block and a guiding slot, said lock sheet is installed with a base sheet and a wing sheet, said base sheet and said wing sheet are installed in parallel and a sheet hole is installed on said wing sheet with respect to the location wherein said latching block is installed;
a plurality of first conduction terminals respectively received in said first terminal channels; and
a plurality of second conduction terminals respectively received in said second terminal channels.

7. The mini PCI express connector according to claim 6, wherein said insulation housing is made of plastic material and is further installed with at least one scoop hole that is disposed below said insertion surface.

8. The mini PCI express connector according to claim 7, wherein said scoop hole is in a rectangular shape.

9. The mini PCI express connector according to claim 6, wherein said latching block is disposed at an upper end of said fastening seat, said guiding slot is disposed below said latching block for allowing said base sheet to sleeve in; two ends of said latching block are respectively provided with a guiding angle for allowing said latching block to sleeve in said sheet hole, so that said lock sheet is prevented from being released from said wing sheet.

10. The mini PCI express connector according to claim 6, wherein said insulation housing is further installed with a tenon disposed rear to said fastening seat for being fastened in a tenon hole of a circuit board.
